(19) United States
(12) Patent Application Publication
(10) Pub. No.: US 2014/0280543 A1
(43) Pub. Date: Sep. 18, 2014

(54) SYSTEM AND METHOD FOR CONNECTING PROXIMAL USERS BY DEMOGRAPHIC & PROFESSIONAL INDUSTRY

(71) Applicant: HALBERDCROSS LLC, Houston, TX (US)

(72) Inventor: James MURPHY, Walnut Creek, CA (US)

(73) Assignee: HALBERDCROSS LLC, Houston, TX (US)

(21) Appl. No.: 13/830,587

(22) Filed: Mar. 14, 2013

(51) Int. Cl. H04L 12/58

(52) U.S. Cl. CPC H04L 51/04
USPC 709/204

(57) ABSTRACT

The present disclosure provides systems and methods for a social networking service that can connect users in a similar industry or business based on the location of a user's electronic devices. The method can include receiving profile and location information from a first electronic device, determining based on an association method relevant and proximally located electronic devices, and transmitting the determined proximal electronic devices to first electronic device.

### FIELD OF TECHNOLOGY

The present disclosure relates generally to social networking applications, and more specifically, to a social networking application that analyzes current user location and profile data of its user community to recommend connections to a current user.

### BACKGROUND

The user of an electronic devices (for example, tablet computers and smart phones), can enable the user to communication with people all over the globe from almost any location. Electronic devices utilize various communication networks to not only help users stay in communication but can also enable users to find information, resources, entertainment, and even new people to interact with on various levels. Additionally, electronic devices can also be enabled to access geographical location information relating to the current location of the electronic device. Conventional systems and methods of determining the location of an electronic device typically determine an approximate location of the electronic device. For example, GPS systems identify location of an electronic device by GPS coordinates that are indicative of an approximate longitude and latitude of the electronic device. Triangulation of the location of an electronic device with respect to cellular towers also identifies an approximate location of the electronic device. In another conventional system, which determines an electronic device's location using Wireless Fidelity (Wi-Fi) access points, when an electronic device is determined as being visible to the device or accessible by the device, the location associated with the MAC address (typically longitude and latitude coordinates) of the Wi-Fi hotspot is approximated as the location of the electronic device.

There currently exist a variety of social networks such as FACEBOOK™, TWITTER™, INSTAGRAM™, MYSPACE™, GOOGLE+™, and LINKEDIN™. These established networks have mobile variants that serve as extensions of their webpage services. In LBS (Location Based Services) utilization, the application of an electronic device acquires the user's location and transmits the location to a server, which responds with information relevant to the application's need. The use of electronic device LBS (Location Based Services) information can be used but is not limited for “geo-tagging” photos, enabling “check-ins” at establishments, allowing for the user to update their status with a location, resource tracking, turn by turn navigation, location based advertising, locating services or skilled persons, location based games revolving around various types of venues, location based social networking, and also location based dating applications. Social networks can create personal social or business networks through the addition of other members that are known to the user directly or indirectly through interests, school, workplace, or mutual friends. Some applications can create a social network based on the proximity of other users in real time.

The existing variety of social networks are designed to allow users to make virtual connections with other users after meeting them in the physical world. Users can reconnect or keep in touch with social or business contacts.

### BRIEF DESCRIPTION OF THE DRAWINGS

In order to describe the manner in which the features of the disclosure can be obtained, a more particular description of the principles briefly described above will be rendered by reference to specific examples thereof that are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 is a block diagram of a system for real-time interaction between proximal electronic devices via location modules and a data network connection to a communication network, in accordance with an example implementation of the present technology;

FIG. 2 is a flow diagram of a method of connecting proximal users by demographic and profile information in accordance with an example implementation of the present technology;

FIG. 3 is an example front view of an electronic device illustrating an example of a system configured user interface (UI) on an electronic device with the application installed and ready to be selected, in accordance with an example implementation of the present technology;

FIG. 4 is an example screenshot of a UI on an electronic device illustrating connecting proximal users by demographic and profile information displayed on an electronic device, in accordance with an example of the present technology;

FIG. 5 is an example screenshot of a UI on an electronic device illustrating a search result list of proximal users that the server 102 has compiled, in accordance with an example of the present technology;

FIG. 6 is an example screenshot of a UI on an electronic device illustrating an exemplary user profile that would be displayed once another user has opted to see a more detailed profile than that shown in FIG. 5 in accordance with an example of the present technology;

FIG. 7 is an example screenshot of a UI on an electronic device illustrating a “Connections” page in which a user is notified of other proximal users that share an interest in meeting, in accordance with an example of the present technology;

FIG. 8 is an example screenshot of a UI on an electronic device illustrating a list of local meetings hosted by other users that the exemplary user has the option of attending as determined by the user's location, in accordance with an example of the present technology;

FIG. 9 is an example screenshot of a UI on an electronic device illustrating a page that the exemplary user will utilize to create a local meeting spot and invite other users in accordance with an example of the present technology;

### DETAILED DESCRIPTION

Various examples of the disclosure are discussed in detail below. While specific implementations are discussed, it should be understood that this is done for illustration purposes only. A person skilled in the relevant art will recognize that other components and configurations can be used without parting from the scope of the disclosure.

Electronic devices can include, but are not limited to, portable communication devices, mobile communication devices, mobile computers, smartphones, computing pads, tablet computers, personal computers, desktop computers, laptop computers, netbooks, servers, routers, set-top phones, or other electronic devices capable of at least accepting data, transmitting data, and executing commands.

Highlighting can include, but is not limited to, changing the color of the graphical item, changing the font or appearance of the graphical item, applying a background color to the graphical item, superimposing a block of semi-transparent color over the graphical item, placing a border around the graphical item, enlarging the graphical item as compared to other graphical items proximate to the highlighted graphical item, or other similar and known methods of highlighting graphical items or text items display on a display screen.

Memory can include to, but is not limited to, transitory memory and non-transitory memory. For example, non-transitory memory can be implemented as Random Access Memory (RAM), Read-Only Memory (ROM), flash, ferromagnetic, phase-change memory, and other non-transitory memory technologies.

Location aware can include, but is not limited to, the ability of an electronic device to passively or actively determine its current geographical location. For example, an electronic device can determine its current geographical location locally by using such technologies as Real-Time Locating System (RTLS), Wireless Personal Area Network (WPAN), Wireless or Wired Local Area Network (LAN) or Digital Enhanced Cordless Telecommunications (DECT) for determining the location of the electronic device. An electronic device can also determine its current geographical location regionally by using technologies such as 3rd Generation Partnership Project (3GPP), Global System for Mobile Communication (GSM) or Long Term Evolution (LTE), or other radio access technologies to determine the electronic devices location. An electronic device can also determine its current geographical location globally by using technologies such as Global Positioning System (GPS) or Galileo™. All of these communication mediums can be used to triangulate the location of the electronic device by utilizing satellite, cellular and/or Wi-Fi triangulation or any other technique, program or algorithm that uses the network for triangulation purposes. While the above describes specific examples of technologies used to configure an electronic device for location-awareness, it will be understood that any other suitable technology by which an electronic device can determine the electronic device's location or determine a relative location of the electronic device can be implemented.

The present disclosure provides systems and methods for a social networking service that can connect users in a similar industry or business based on the location of a user's electronic devices. In one example embodiment, the present disclosure provides for communication between two proximal electronic devices, where the users of the electronic devices are attending the same business conference. The system and method can include a User Interface (UI) (for example, a mobile application executable on the electronic devices, a web-based application, or any other user interface executable on an electronic device), a location module (for example, GPS), a communication link, and one or more audio, video, or both audio and video devices. The electronic device can be configured to provide an alert to the user when a proximal user attempts to communicate. An alert can also be configured to notify the user when the association method has matched a proximal user with similar business interests. In an example embodiment, the request for interaction can be a request to meet in person, invitation to a private or group meeting, chat via messaging or chat over a video-feed. Users can alternatively communicate using a built-in messenger or through a third party application such as SKYPE™, AOL™ Instant Messenger, GOOGLE™ Chat, or APPLE™ FACETIME. Users can Request to meet in person through the creation of either a private or open meeting.

An example association method can be executed either by a server with which the electronic device has established a connection or by the electronic device itself. The example association can method work with a plurality of inputs which is not limited to the following: current user's profile information, other user's profile information, privacy settings, algorithmic parameters set by individual users and interpreted by the system, and the location of all electronic devices. These inputs are utilized by the association method to determine the rank and relevance of proximal users. Profile information of each user can include but is not limited to the user's place of industry, industry of business, professional industry, conferences attended or attending, business connections, business contacts, degrees or certifications, published papers, professional affiliations, full name, user name, device name, home location, office location, telephone number, email, check-in locations, scheduled destinations, and communication options available. The following example embodiment of the association method will utilize a subset numbering five of the profile information samples aforementioned: business, industry of business, degrees held, home location, and current location. Table 1 is a table containing a subset of the profile information for five people named Joe, Sally, Sam, Jane and Bob. None of the five users have elected to utilize any of their privacy settings. The user Sam queries his electronic device for proximate users nearby. For every match, the association method gives a point to the counter for each proximal user. In the business iteration the association method compares whether or not the two users being compared work for the same company. In the Industry of business area the associated method looks for similar fields such as Medicine and Medical Devices. In the Degrees Held section, the algorithm looks at related majors such as majors that would be a part of the same school within a College or University such as Biological Engineering and Electrical Engineering, or Philosophy and Sociology. Home Locations are compared by city and then State. The current location is then analyzed by distance between the two locations. If a proximal user is in the same building their respective counter receives n-1 points, n being the number of distances out of all proximal users. The second closest proximal user receives n-2 points, the third n-3 and so on. These counters are then ranked by greatest to least with the best-matched users having totaled the greatest amount of points.

TABLE 1

| | User: | | | | |
|---|---|---|---|---|---|
| | Joe | Sally | Sam | Jane | Bob |
| Business | A | B | C | C | A |
| Industry of | Law | Oil + Gas | Medicine | Medical | Business |
| Business | | | | Devices | |
| Degrees Held | Economics, | Mechanical | Biological | Electrical | Economics, |
| | J.D. | Engineer | Engineer, | Engineering, | M.B.A |
| | | | Ph. D | Ph. D | |
| Home | New York, | Houston, TX | Houston, TX | San | New York, NY |
| Location | NY | | | Francisco, CA | |
| Current | Building C | Building B | Building C | Building A | Building B |
| Location | | | | | |

Table 2 illustrates a table ranking Sam with the other users after examination of every profile factor. Sally and Jane are equally matched for first pace, followed by Joe in third and Bob in fourth. Table 3 displays an evaluation after Sam, attending the conference of “The Future of Oil and Gas in the Artic” in Building B, had decided to adjust association method factors and privacy settings to search for people in the same conference. Joe would be the only individual made available by the association method. The other users would have a null ranking and would not show up on the matched list output of the example association method. Table 4 displays an evaluation after Sam had decided to adjust association method factors and privacy settings to search for people located nearby from his hometown or someone who studied in the same subject matter in school.

TABLE 2

| | | | Rank | | | | |
|---|---|---|---|---|---|---|---|
| Sam | | Points | After1 | After2 | After3 | After4 | Final |
| | Joe | 0-0-0-0-2 | — | — | — | — | 3^{rd} |
| | Sally | 0-0-1-1-1 | — | — | 2 | 2 | 1^{st} |
| | Jane | 1-1-1-0-0 | 1 | 1 | 1 | 1 | 1^{st} |
| | Bob | 0-0-0-0-1 | — | — | — | — | 4^{th} |

TABLE 3

| | | | Rank | | | | |
|---|---|---|---|---|---|---|---|
| Sam | | Points | After1 | After2 | After3 | After4 | Final |
| | Joe | 0-0-0-0-2 | — | — | — | — | 1^{st} |
| | Sally | 0-0-0-0-0 | — | — | — | — | — |
| | Jane | 0-0-0-0-0 | — | — | — | — | — |
| | Bob | 0-0-0-0-0 | — | — | — | — | — |

TABLE 4

| | | | Rank | | | | |
|---|---|---|---|---|---|---|---|
| Sam | | Points | After1 | After2 | After3 | After4 | Final |
| | Joe | 0-0-0-0-0 | — | — | — | — | — |
| | Sally | 0-0-1-1-1 | — | — | 1 | 1 | 1^{st} |
| | Jane | 0-0-1-0-0 | — | — | 1 | 2 | 2^{nd} |
| | Bob | 0-0-0-0-0 | — | — | — | — | — |

The example association method can also develop a better understanding about a particular user by keeping track of the matches that the user often makes with proximal users. The example association method can weigh the points earned by particular counters heavier than those of another counter, to make one input from the proximal users input information more important than another input from the same user. For example, Sam meets a lot of people from New York so the example association method can adjust to this by weighing the points for hometown by a factor of two (meaning that proximal users receive two points rather than one for being from the same hometown as Sam). The more a user uses the example association method, the better the example association method gets at dynamically adjusting the profile information counters to match it's user with better and better proximal users.

FIG. 1 is a block diagram representing an electronic device 101 interacting with a server 102 that can provide information relating to relevant proximal electronic devices 104. For example, in FIG. 1, electronic device 101 is interacting with server 102 via a data connection to a communication network 103. In FIG. 1, electronic device 101 can connect to a communication network 103 via a communication module (not shown). For example, communication module can include one or more of a mobile telecommunications module, a cellular communication module, a Wireless Fidelity (Wi-Fi) module, Ethernet or landline module, or any other module, which allows for the communication between the electronic device 101 and the server 102. Server 102 can communication with a database 106 via communication network 103, an internal network, an internal bus or any other acceptable transmission medium. Database 106 can store location information and profile information provided from the electronic device 101 and proximal electronic devices 104. Server 102 can search database 106 for proximal connections with similar stored profile information. Profile information can also be stored locally on the electronic devices 101 and 104, on the server 102 or on both. For example, profile information can include, but in not limited to place of business, industry of business, professional industry, conferences attended or attending, business connections, business contacts, degrees or certifications held, published papers or professional affiliations. Profile information not associated with a user's business affiliations can also be stored. For example: full name, user name, device name, home location, office location, telephone number, email, checked-in location, scheduled destinations, and communication options.

Examples of electronic device 101 and a proximal electronic device 104 for connecting proximal users by demographic and profile information can be defined as any device that is capable of at least accepting data, transmitting data, and executing commands. Example electronic devices can include, but are not limited to, portable communication devices, mobile communication devices, mobile computers, smartphones, computing pads, tablet computers, personal computers, desktop computers, laptop computers, netbooks, servers, routers, set-top phones, or other electronic devices capable of at least accepting data, transmitting data, and executing commands. Electronic devices 101 and 104 can include a memory (for example high-speed random access memory, non-volatile memory, flash memory, solid-state memory), one or more central processing units (CPU, which for example can run or execute various software programs and/or sets of instructions stored in memory to perform various functions for the electronic devices 101 and 104), a display (for example, a touch sensitive display or touchscreen), a communication module (for example, radio frequency (RF) circuitry or global positioning system), an image module (for example, a still image camera, a moving image camera), audio circuitry (for example, a speaker, a microphone, a headset jack), a power system (for example, a battery, alternating current (AC) adapter), software components (for example an operating system such as Windows, Linux OSX, UNIX). Electronic devices can also be location-aware. It should be appreciated that devices 101 and 104 are only one example of an electronic device 101 and 104, and that electronic devices 101 and 104 can have more or fewer components than shown, can combine one or more components, or can have a different configuration or arrangement of the components.

A server 102 can be defined as any device that is capable of running one or more services that serve the needs of other computers or clients on the same communications network. Examples of servers are, web server, communications server, database server, name server, proxy server, print server, and in this specific environment an application server. An application server is a server dedicated to running certain software applications (for example, a real-time audiovisual interaction server). A server can have at least one type of memory (for example high-speed random access memory, non-volatile memory, flash memory, solid-state memory, hard disks), one or more central processing units (CPU, which for example can run or execute various software programs and/or sets of instructions stored in memory to perform various functions for the server 100), a communication module (for example, radio frequency (RF) circuitry or global positioning system), a power system (for example, a battery, alternating current (AC) adapter), software components (for example an operating system such as Windows, Linux OSX, UNIX and an application such as a real-time audiovisual interaction application). It should be appreciated that server 102 is only one example of a server, and that server 102 can have more or fewer components than shown, can combine one or more components, or can have a different configuration or arrangement of the components.

FIG. 2 is a flow diagram of an example method of real-time interaction between a user's electronic device and a proximal electronic device based on demographic and profile information. The method 200 illustrated in FIG. 2 is provided by way of example, as there are a variety of ways to carry out the method. Additionally, while the sample method is illustrated with a particular order of steps, those of ordinary skill in the art will appreciate that FIG. 2 and the steps illustrated therein can be executed in any order that accomplished the technical advantages of the present disclosure and can include fewer steps than illustrated.

Each block shown in FIG. 2 represents one or more processes, methods, or subroutines, carried out in example method. The steps illustrated in FIG. 2 can be implemented in an example system including, but not limited to an electronic device 101, a server 102, a proximal electronic device 104, a communications network 103 and database 106. Each block shown in FIG. 2 can be carried out by the electronic device 101 or 104 and the server 102, all of which contain a form of processor and are capable of transmitting data, receiving data, and executing commands. The flow chart illustrated in FIG. 2 will be described in relation to and make reference to the electronic device 101, server 102, proximal electronic device 104, database 106, the communications network 103 in FIG. 1.

Method 200 can begin at block 210. At block 210, a request is received at server 102 from electronic device 101 to locate one or more proximal electronic devices 104. The server 102 can also receive the electronic device's current location information, log-in credentials for a social networking site, user input data from electronic device 101, and location proximity threshold. Server 102 receives the request it can compare the data received in the request with state stored in database 106. The user can adjust a location proximity threshold. The location proximity threshold can determine a distance from the current location of electronic device 101 for the server 102 provide the association method to match users of proximal electronic devices 104 within the threshold value. The server 102 can also operate on a default threshold. After the request from electronic device 101 is received by server 102, the method can proceed to block 220.

At block 220 the server 102 can query an accessible database 106 for proximal electronic devices 104 within the threshold of the requesting electronic device 101. Database 106 can be located internal or external to server 102. The server 102 can access the database 106 via an internal data bus or communications network 103. The database 106 can return a preliminary list of proximal electronic devices 104 and the profile information related to those proximal electronic devices to the server 102. Once the server 102 has received a preliminary list and profile information from the database 106, the method proceeds to block 230.

At block 230 the association method running on server 102 can compare the profile information of the requesting electronic device 101 with the profile information of the proximal electronic devices 104 on the preliminary list provided from block 220. The profile information can include, but is not limited to business, industry of business, employment field, professional industry, current employment company, job or position description, conferences attended or attending, business connections, business contacts, degrees or certifications held, published papers, professional affiliations, full name, user name, device name, home location, office location, telephone number, email, checked-in location, scheduled destinations, communication options, and mutual connections from a social networking sites. The user of electronic device 101 can also enter information to be used for by the association method for selecting proximal electronic devices. For example, the user can enter the name of an establishment where they are planning on meeting colleagues that evening or the name of a seminar they are currently attending. After the association method completes the comparison and returns a list of relevant proximal electronic device to server 102, the method proceeds to block 240.

At block 240 the server 102, transmits a relevant list of proximal electronic devices 104 to the requesting electronic device 101. The list provided to electronic device 101 can include the comparison data for which the devices were matched. For example, the user of electronic device 101 could receive a list of two contacts, each of which is attending the same conference. The list provided can also be ranked with the most relevant proximal electronic device at the top of the list. For example, there can be two proximal electronic devices that are at the same conference, but one of the proximal electronic devices could work at the same company at the user of electronic device 101. The association method running on server 102 can rank this proximal electronic device higher based on more relevant profile information. The list can also be displayed on the screen of electronic device 101. Profile and contact information corresponding to any proximal devices on the list returned by the server 102 to the electronic device 101 can be browsed. The list returned to electronic device 101 is formatted by the UI for display on the electronic device 101. Such formats can include but are not limited to, a list, a list with descriptions, a map, or a map showing the electronic device's location along with the locations of popular meeting sites and other proximal electronic devices.

FIG. 3 illustrates a front view of an example electronic device 301. Electronic device 301 can include a touchscreen 309, a user interface (UI) 310 and one or more selectable applications with application icons 308 that can be highlighted for selection. For example, the one or more selectable applications can be presented in a list. Each of the one or more selectable applications can be represented by an icon. The icons can be selected via user inputs received at the electronic device. For example, such user inputs can include double or single clicking, gaze tracking, motion inputs, audible inputs, voice command, tap inputs at the touch screen, stylus inputs, key pressings, or any other input which can be received by the electronic device 301 to indicate that a selection has been made. When an application is selected, the icon corresponding to the selected application can be highlighted, thereby designating or distinguishing the selected application from the remaining applications presented in the list of applications. User Interface 310 displays one or more user-selectable applications 308, including a highlighted application 307 that can represent an application configured to execute the interaction with a proximal electronic device. In another implementation, the interaction with a proximal electronic device can be incorporated with existing applications executable on the electronic device 301.

After a user executes the highlighted application 307 shown in FIG. 3, the application 307 is initiated and displayed on the touchscreen 309 of the electronic device 301. An example screenshot of this can be seen in FIG. 4. In FIG. 4, when highlighted application 307 is initiated, a user interface 410 is displayed on the touchscreen 409 of the electronic device 401 Also illustrated in FIG. 4, UI 410 can included one or more selectable options 411, 412, 413, 414, 415, 416, 417, and 418. The selectable options can include a status 411, a who's nearby option 412, a search option 413, a current connection option 414, a messages option 415, a host a meeting option 416, a profile option 417 and a settings option 418. The status option 411 can set a user's current status. For example, a user can set their status to “open for a meeting”, if they would are open to meeting with new people. A user can also set their status to “busy” if they do not wish to be bothered. In one example implementation, the status can show up in the search results of proximal electronic devices provided from the server. This can notify a user of which users of proximal electronic devices are open connecting. The who's nearby option 412 can send a request for the server to notify the user of electronic device 401 of any proximal electronic devices which match the user's profile information. The search option 413 can search for specific users based information relating to that user. For example, if a user of electronic device 401 is at a technical conference and wants to connect with fellow employees of Widget Corporation the user can enter “Widget Corporation” in search option 413 to determine if any fellow employees are at the conference. The current connection option 414 can display all connections electronic device 401 has accumulated. The current connections can be displayed in various formats including but not limited to: a list, a list with descriptions, a map, or a map showing the electronic device's location along with the locations of popular meeting sites and other electronic devices. The messages option 415 can display an inbox screen where the user can view new, archived, read, sent, and drafted messages. For example, a user of electronic device 401 can draft a message to a proximal electronic device they would like to connect with. The host a meeting option 417 can coordinate a meeting with one or more proximal electronic devices. The meeting can be a private or public meeting and can have host one or more proximal electronic devices. For example, a user of electronic device 401 can host a meeting after a conference at the hotel they are staying at for all proximal electronic devices that are staying at the same hotel and attending the same conference. The Profile option 417 can view or update the user of electronic device 401 profile information. The profile information can be used by the association method on the server, to determine relevant proximal electronic devices. Profile information can include but is not limited to, log-in credentials for a social network, business, industry of business, employment field, professional industry, current employment company, job or position description, conferences attended or attending, business connections, business contacts, degrees or certifications held, published papers or professional affiliations, full name, user name, device name, home location, office location, telephone number, email, checked-in location, scheduled destinations, and communication options. The user can choose to provide a pseudo name as a result of privacy concerns. A user can restrict the profile information shared with other devices and insist on being prompted for confirmation to share info when requested. The profile information can be updated automatically via a social network or manually by a user. For example, a user at a conference can update their profile information to show they are attending a conference. This can provide the association method with information that aids in providing relevant proximal electronic devices. The settings option 418 can allow the user edit items including, but not limited to, user profile password, e-mail address attached to account, subscriptions, font of the application, display text size and font.

FIG. 5 illustrates a User Interface 509 that can be displayed on an electronic device 501 when the who's nearby option 412 is selected from the UI illustrated in FIG. 4. FIG. 5 can show the relevant proximal users found by the association method and returned by the server. For example, a user of electronic device 501 can request from a server, all relevant proximal electronic devices. The association method on the server can compare the request and the user's profile information with all proximal electronic devices' profile information and can return the relevant proximal electronic device to the requesting electronic device 501. For example, the user of electronic device 501 can request to connect with anyone at the same technical conference. The user can update their profile information with the conference details and submit a request to the server. The association method on the server can use electronic device's 501 current location and profile information to locate possible connections already stored in an accessible database. The results from the association method can then be returned to electronic device 501, which is illustrated in a example screenshot in FIG. 5. Search option 513 can further refine the results returned from the server. Relevant proximal electronic devices 519 are shown on UI 510 and can be further accessed by interaction with touchscreen 509. The relevant proximal electronic devices 519 can be ranked from most relevant to least relevant based on the profile information and location information compared by the association method. Relevant proximal electronic device profile and location information can be displayed on UI 510. A profile picture 520, a name 521, and profile information 522 can be displayed. For example, profile information 522 can include business, industry of business, employment field, professional industry, current employment company, job or position description, conferences attended or attending, business connections, business contacts, degrees or certifications held, published papers or professional affiliations, full name, user name, device name, home location, office location, telephone number, email, checked-in location, scheduled destinations, communication options, mutual connections from a social networking sites. A proximal electronic device's current status 511 and current location 523 can also be displayed.

FIG. 6 illustrates an example screenshot of an example user profile that can be displayed on the touchscreen 609 of electronic device 601. When a profile 519 is selected in FIG. 5, a user can be navigated to the profile of a proximal user. Information area 622 can provide information about the selected user of a proximal electronic device including name, job, interests, business, industry of business, employment field, professional industry, current employment company, job or position description, conferences attended or attending, business connections, business contacts, degrees or certifications held, published papers or professional affiliations, full name, user name, device name, home location, office location, telephone number, and email. Places where a user of a proximal electronic device has recently been located can be shown in box 625. Contact information 626 and meeting request 627 are available so a user of electronic device 601 can make contact with a relevant user of a proximal electronic device. For example, a user of electronic device 601 can contact a proximal electronic device through a built-in messenger, third-party messenger, built-in video chat, third-party video chat, phone call, e-mail, SMS, MMS, and Voice-Over IP (VoIP). Mutual information 628 can contain details on how the association method decided the user of a proximal electronic device was relevant. For example, Mutual information 628 can show details on a conference that both users are attending. It can also show location information, for example a distance from electronic device 601. The view location option 608 can show the location of a proximal electronic device. The location of the contact can be viewed by methods including, but not limited to a map, a street-view map, or through the use of another application on the electronic device 601. Interesting contact toggle 621 can be an icon where a user of electronic device 601 can save the contact to current connects 419, shown in FIG. 4.

FIG. 7 illustrates an example screenshot of the user interface 710 that can be displayed on an electronic device 701 in response to the selection of a meeting option 627 illustrated in FIG. 6. The user of a proximal electronic device can respond or initiate a meeting with the user of electronic device 701. A meeting status 730, a meeting request options 731, a meeting time 732, potential times for a meeting request 733 and the current distance 734 can be seen on UI 710. For example, a meeting response or request can include, but is not limited to an image or text providing information about parties included in the meeting, text providing information about the requested meeting time and place, or electronic details for a meeting.

FIG. 8 illustrates an example screenshot of the UI 810 displayed on electronic device 801 that can list proximal meetings hosted by users of proximal electronic devices. Toggle option 835 would allow the user of electronic device 801 to filter between public and private listings. The Title 836 and host 837 can be displayed on UI 810. Meeting Details 833 can include but is not limited to the invite, the location, the time, public or private and whether or not the meeting is open to all users.

FIG. 9 illustrates an example screenshot of the UI 909 displayed on an electronic device 901 that can show the creation of a meeting by the user of electronic device 901. The time entry 938 is where the user can set the time for meeting they wish to host. The title entry 939 is where the user of electronic device 901 can create a title for the meeting they wish to host. The location entry 940 is where the user of electronic device 901 can set the place for the meeting. The location entry 940 can have features that can include, but are not limited to a map of proximal locations that appears once the location entry 940 has been selected, or a listing of nearby locations. The user of electronic device 901 can decide who to invite to the meeting by using the meeting invitation entry 941. For example the user of electronic device 901 can select users from their contact list, users of proximal electronic devices, or a combination of the two. The meeting privacy setting 942, can set the meeting is private, public or open.

1. A method for providing an interaction between one or more proximal electronic devices, comprising:
Receiving, at a server, a request for proximal commonly connected electronic devices, the current location and login credentials for a social network of a requesting electronic device;
Searching, in a database accessible by the server, current location information proximal to a requesting electronic device;
Comparing, at a server, profile data between a requesting electronic device and one or more proximal electronic devices;
Transmitting, from the server to the requesting electronic device, a list of proximal electronic devices that have mutual profile data.
